(19) United States
(12) Patent Application Publication
(10) Pub. No.: US 2009/0040889 A1
(43) Pub. Date: Feb. 12, 2009

(54) Wobble signal demodulation method and wobble signal demodulator

(75) Inventor: Takashi Nakagawa, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/219,743

(22) Filed: Jul. 28, 2008

(30) Foreign Application Priority Data
Aug. 6, 2007 (JP) 2007-204076

(51) Int. Cl. G11B 7/007

(52) U.S. Cl. 369/44.13; G9B/7.029

(57) ABSTRACT

Pseudo synchronization due to crosstalk is detected with a small circuit scale in decoding address information from an MSK-modulated wobble signal. An MSK mark detection unit detects MSK marks periodically placed as synchronization signals in a wobble signal. A first synchronization state determination unit determines synchronization establishment with a detection position of each MSK mark as a reference, or out-of-synchronization. A prediction timing generation unit periodically generates a timing at which each MSK mark is to be detected based on the synchronization position after the establishment of synchronization. A second synchronization state determination unit compares a detection timing with the prediction timing, after the MSK mark is detected at a predetermined position within a period a predetermined number of times in succession, and determines the synchronization position as a pseudo synchronization position due to crosstalk on condition that there is a shift between the detection timing and the prediction timing.

### BACKGROUND OF THE INVENTION

1. Field of the Invention

The present invention relates to demodulation of a wobble signal, and more particularly, to a technology for demodulating an MSK (Minimum Shift Keying)-modulated wobble signal.

2. Description of Related Art

There are various standards of optical recording discs (hereinafter, also referred to simply as “disc”) such as DVD+R/RW, DVD-R/RW, DVD-RAM, HD DVD-R/RW/RAM, and BD (Blu-ray Disc)-R/RE. Those discs have a recording film with a groove formed therein along a spiral recording track, for guiding a laser beam. The groove meanders with a frequency and an amplitude that are prescribed in each standard.

The meandering of the groove is called wobbling, and a signal reproduced therefrom is called a wobble signal. In general, in a case of performing a reproducing or recording operation for a disc, a digital wobble signal obtained by subjecting a wobble signal to A/D conversion is multiplied to a prescribed frequency by a PLL (Phase Locked Loop) circuit, to thereby generate a reference clock. A normal wobble signal has a single frequency because the wobble signal is used mainly for extracting the reference clock by employment of the PLL circuit. The wobble signal is partially modulated without inhibiting the operation of the PLL circuit, whereby address information indicative of a physical position on a disc, which is necessary for the reproducing or recording operation, is embedded in the wobble signal. The wobble signal thus modulated is called ADIP (Address In Pre-Groove).

Various wobble modulation methods are employed depending on the standard. For example, a modulation method called MSK (Minimum Shift Keying) is employed for a BD. In this case, the ADIP for the MSK modulation method is described in detail by taking a BD as an example.

As an ADIP format of a BD, three units of an ADIP unit, an ADIP word, and an RUB (Recording Unit Block) are defined.

The ADIP unit is a unit for identifying a synchronization signal. A single ADIP unit includes 56 wobbles, and a period of one wobble corresponds to 69 T. Note that “T” represents a minimum unit time for a recording or reproducing operation and corresponds to a single period of the reference clock. Further, the ADIP unit includes three types of wobbles, that is, a monotone wobble, an MSK wobble, and an STW (Saw Tooth Wobble). By a combination of those wobbles, various types of ADIP units such as a monotone unit, a reference unit, a sync unit (sync 0 unit, sync 1 unit, sync 2 unit, sync 3 unit), and a data unit (data 1 unit, data 0 unit) are formed.

FIG. 6 shows ADIP units. Black rectangles shown in FIG. 6 represent MSK wobbles, and white rectangles represent wobbles other than the MSK wobbles. As shown in FIG. 6, each MSK wobble corresponds to an MSK-modulated portion of an analog wobble. In the MSK modulation method, two frequencies are used. One of the frequencies is equal to a frequency of a reference carrier signal, and the other of the frequencies is 1.5 times as high as the frequency of the reference carrier signal. Specifically, assuming that the reference carrier signal is represented as cos (ωt), “0” is represented as cos (ωt) or −cos (ωt) that is an inverted signal thereof, and “1” is represented as cos (1.5 ωt) or −cos (1.5 ωt) that is an inverted signal thereof. In the ADIP, the MSK-modulated portion includes three carrier period sections of cos (1.5 ωt), −cos (ωt), and −cos (1.5 ωt). Three wobbles corresponding to the three carrier period sections are called an MSK mark.

Note that the monotone wobble is a wobble corresponding to cos (ωt), and the STW is a wobble corresponding to “cos (ωt)−(¼)×sin (2 ωt)” or “cos (ωt)+(¼)×sin (2 ωt)”.

As shown in FIG. 6, first three wobbles (0th to 2nd carrier periods) of various types of ADIP units are MSK wobbles. Those MSK wobbles each function as a synchronization signal for taking bit synchronization during the reproducing or recording operation. In the following description, 56 wobbles that form a single ADIP unit are also called synchronization blocks.

Further, in the ADIP units other than the monotone unit and the reference unit, MSK marks are subsequently placed in addition to the first three wobbles. Based on positions of the MSK marks, the types of the ADIP units can be identified. For example, an ADIP unit including 13th to 15th wobbles (12th to 14th carrier periods) corresponding to the MSK mark is a data 1 unit with a data bit of address information indicating “1”. An ADIP unit including 15th to 17th wobbles (14th to 16th carrier periods) corresponding to the MSK mark is a data 0 unit with a data bit of address information indicating “0”.

FIG. 7 shows an ADIP word. The ADIP word is a unit for decoding address information and includes 83 ADIP units. Error detection and correction for the address information is performed in units of ADIP words. First eight ADIP units among the 83 ADIP units forming the ADIP word are a monotone unit, a sync 0 unit, a monotone unit, a sync 1 unit, a monotone unit, a sync 2 unit, a monotone unit, and a sync 3 unit. Based on those ADIP units, an offset position in the ADIP word can be identified. Seventy-five ADIP units from a ninth ADIP unit of the ADIP word correspond to an address code having 4×15 bits. By decoding those address codes, the address information on the disc can be obtained.

FIG. 8 shows an RUB. As shown in FIG. 8, the RUB includes three ADIP words. Recording of data onto a disc is performed in units of RUB.

As described above, the ADIP includes a plurality of synchronization blocks, and the synchronization signal is provided in a first block of the synchronization blocks. Further, the address information is written into a predetermined position in a predetermined synchronization block with the position of the synchronization signal being used as a reference. With respect to the ADIP, the synchronization signal is detected to establish synchronization, and the address information is decoded (for example, see Japanese Unexamined Patent Application Publication No. 2003-317388).

The address information is decoded in the following manner. That is, the synchronization signal (which corresponds to the first MSK mark of the ADIP unit in the case of the MSK modulation method) from the wobble signal, and synchronization is established with the position of the detected synchronization signal being set as a synchronization position. After that, bit information is obtained from the wobble signal based on the synchronization position, whereby an address is generated. Accordingly, in order to obtain correct address information, it is important to correctly detect the position of the synchronization signal.

The synchronization signal is incorrectly detected mainly because of disturbance due to a spindle operation or a physical defect of a disc, and crosstalk. Among the causes, the former is an accidental cause which is hereinafter referred to as accidental noise. The crosstalk, which is described in detail later, is generated with a period of several tracks. If the position of the synchronization signal is erroneously detected during a period in which the accidental noise or the crosstalk is generated, and if synchronization is established based on the synchronization signal position thus detected, the address information is decoded based on the incorrect synchronization position. As a result, there arises a problem in that the correct address information cannot be obtained and recording or reproduction operation may be carried out in the incorrect position on the disc.

There are proposed methods of correctly detecting the position of the synchronization signal from the signal having synchronization signals periodically placed therein, from various points of view.

For example, Japanese Unexamined Patent Application Publication No. 2000-003550 discloses the following method. That is, when the synchronization signal is detected, a subsequent synchronization signal should appear at a timing after elapse of a predetermined period of time that is prescribed in each standard, so a detection window is provided only for a predetermined period of time with the prescribed timing being as a center, whereby the synchronization signal is detected only in the provided detection window. With the method, the synchronization signal is prevented from being erroneously detected due to an effect of noise at the timing at which the synchronization signal should not appear.

Further, Japanese Unexamined Patent Application Publication No. 09-008793 discloses the following method. That is, a synchronization protection circuit is provided in a subsequent stage of a synchronization signal detection circuit, and synchronization is established after performing backward protection for determining that synchronization is established only after confirming that the synchronization signal is repeated several times with a predetermined period. According to the method, it is possible to reduce the possibility of erroneous detection due to the presence of a portion which is not a synchronization signal itself but a portion that happens to match a pattern of the synchronization signal, or due to the effect of noise. Japanese Unexamined Patent Application Publication No. 09-008793 also discloses the following method for the forward protection. That is, after the synchronization is established, when the synchronization signal fails to appear at a prediction timing in a repetitive period, instead of immediately determining that out-of-synchronization occurs, the out-of-synchronization is determined only after the number of times the synchronization signal that should appear at the prediction timing fails to appear reaches a predetermined number of times. According to the forward protection, it is possible to avoid erroneously determining the out-of-synchronization simply because it happens that the synchronization signal is not detected at the prediction timing due to the effect of the accidental noise. In addition, a reduction in processing efficiency of a system can be prevented.

Japanese Unexamined Patent Application Publication No. 2005-327439 discloses a wobble demodulator employing the above-mentioned two methods. The wobble demodulator is provided with a synchronization determination unit. In the synchronization determination unit, a window period (detection window) is provided in each period for detecting the synchronization signal, and a synchronization signal pattern for discriminating the MSK mark is compared with a wobble signal within the detection window, to thereby detect the synchronization signal. When the synchronization signal is detected within the detection window a predetermined number of times in succession, the synchronization determination unit determines that synchronization lock is achieved, that is, determines that synchronization is established. Meanwhile, when the synchronization signal is not detected within the detection window a predetermined number of times in succession, the synchronization determination unit determines that out-of-synchronization occurs (see FIG. 1 and claim 6 of Japanese Unexamined Patent Application Publication No. 2005-327439).

Japanese Unexamined Patent Application Publication No. 2004-134009 discloses a method of detecting a shift of a synchronization position due to crosstalk, in a case of decoding address information from an MSK-modulated wobble signal. In this case, effects of the crosstalk on the synchronization position are first described.

FIG. 9 corresponds to FIG. 4 of Japanese Unexamined Patent Application Publication No. 2004-134009, and shows an example of a conventional wobble demodulation circuit. In an MSK mark section, a frequency and a phase are different between a carrier signal and a wobble signal. Therefore, a multiplied output of the wobble signal and the carrier signal is supposed to be negative in this section. By utilizing the fact, the wobble demodulation circuit shown in FIG. 9 multiplies the wobble signal by the carrier signal, and detects a negative value obtained by integrating the multiplication result in each carrier period, or a negative output value obtained by allowing the multiplication result to pass through a lowpass filter, as the MSK mark.

Specifically, an optical head 402 irradiates an optical recording medium (optical disc) 401 with a light beam, and detects an amount of light reflected from the optical recording medium 401 to output an electric signal. A wobble signal detection unit 403 extracts a wobble signal from the electric signal obtained from the optical head 402 and outputs the wobble signal to a multiplication unit 405 and a carrier signal generation unit 404. The carrier signal generation unit 404 generates a carrier signal from the wobble signal and outputs the carrier signal to the multiplication unit 405. The multiplication unit 405 multiplies the wobble signal by the carrier signal and outputs a multiplied output to an integration unit 406. Further, the carrier signal generation unit 404 outputs a sample-and-hold signal SH to the integration unit 406 in each carrier period. The integration unit 406 integrates the multiplied output from the multiplication unit 405 in each carrier period in response to the sample-and-hold signal SH, and outputs an S/H value of the integration result to a decoding unit 407. The decoding unit 407 decodes digital information containing address information, based on a positive/negative sign of the S/H value obtained from the integration unit 406.

FIG. 10 shows a timing for an operation of detecting an MSK mark by the demodulation circuit shown in FIG. 9. As shown in FIG. 10, in the MSK mark section, the S/H value obtained by the integration unit 406 becomes a negative value. The section in which the S/H value becomes the negative value corresponds to an antiphase portion (−cos (ωt)) of the MSK-modulated portion, which is hereinafter referred to as an MSK mark position. The decoding unit 407 detects the MSK mark position so as to generate an MSK detection signal (which is also referred to as “MSK pulse”) shown in FIG. 10, and establishes synchronization by measuring an output interval between the MSK detection signals, to thereby decode the address information.

Incidentally, in recent years, as a recording density of an optical disc increases rapidly, a pitch between tracks on the disc is narrowed. As a result, crosstalk is more likely to occur between adjacent tracks. Meanwhile, wobbles are formed at predetermined intervals toward an outer periphery from an inner periphery on a disc, but the phase of each wobble between the adjacent tracks is changed little by little due to a difference in perimeter between the adjacent tracks on the disc. For this reason, the wobble between the adjacent tracks is added as a crosstalk component to the wobble of the own track, which affects the detection position and the amplitude of the wobble.

FIG. 11 shows an effect of crosstalk on processing executed by the demodulation circuit shown in FIG. 9. As shown in FIG. 11, when crosstalk is present, a waveform of the wobble signal is deformed, with the result that an output position of an MSK pulse, that is, the position of the detected MSK mark is shifted forward or backward in units of wobbles from the original position. In the following description, the position of the detected MSK mark is referred to as a “detection position” of the MSK mark.

The address information is decoded based on the detection position of the MSK mark. Accordingly, when the detection position is shifted from the original position, pseudo synchronization occurs, and incorrect address information (count value of address counter) is generated as shown in FIG. 12. As a result, recording or reproducing processing may be carried out in an incorrect position on a disc.

Meanwhile, a period of the crosstalk component corresponds to several track periods, and is long enough with respect to the interval between the MSK marks to be placed. Accordingly, in the period in which the crosstalk is generated, an MSK mark serving as a synchronization signal and an MSK mark representing data are disposed to be shifted in the same direction by the same amount within the same synchronization blocks (56 wobbles in a case of BD). Japanese Unexamined Patent Application Publication No. 2004-134009 proposes a wobble demodulation circuit shown in FIG. 13, which is capable of solving the above-mentioned problem by utilizing the fact. Note that FIG. 13 corresponds to FIG. 1 of Japanese Unexamined Patent Application Publication No. 2004-134009.

In the wobble demodulation circuit shown in FIG. 13, a carrier signal generation unit 104 generates a carrier signal cos (ωt) synchronized in phase with a wobble signal detected by a wobble signal detection unit 103, and outputs the generated carrier signal to a multiplication unit 105. In addition, the carrier signal generation unit 104 outputs sample-and-hold signals SH1 and SH2 to an integrator 109 and an integrator 116, respectively.

The sample-and-hold signal SH1 is a pulse signal output when the phase thereof becomes 90° or 270° relative to that of the carrier signal cos (ωt). Accordingly, the integrator 109 performs integration only when the length of an integrated section is as short as a half carrier period and when the multiplication result of the multiplication unit 105 is negative. That is, when the sample-and-hold signal SH1 is not output, the integrator 109 performs integration of only negative values. When the sample-and-hold signal SH1 is output, the integrator 109 outputs an integrated value obtained at that time as an S/H value, and resumes integration from 0. As a result, in an MSK modulation section, the integrated value becomes an outstanding value in five sections in succession. An absolute value of the integrated value has a characteristic of becoming larger especially in central three sections and becoming smaller, in the vicinity thereof, than that in the central three sections. An MSK detection unit 106 including the integrator 109 detects, as the MSK mark, the sections showing such characteristic, and outputs the MSK detection signal.

Specifically, an MSK front detector 114, an MSK leading edge detector 113, an MSK center detector 112, an MSK trailing edge detector 111, and an MSK back detector 110 of the MSK detection unit 106 each hold the S/H value in time-serially consecutive five sections, and each shift the held S/H value at each output timing of the sample-and-hold signal SH1. When a relation between the S/H values held in those five detectors satisfies the above-mentioned characteristic, a pattern detector 115 outputs the MSK detection signal assuming that the MSK mark is detected.

An MSK synchronization detection unit 107 detects the position of the MSK mark from the MSK detection signal output by the pattern detector 115 to thereby determine the synchronization position, and increments a synchronization counter with a first synchronization block being set to 0. For example, in the case of synchronization blocks of an ADIP unit of a BD, one synchronization block is made up of 56 wobbles. Accordingly, the MSK synchronization detection unit 107 counts 56 carrier periods. Note that the MSK synchronization detection unit 107 outputs a value of the synchronization counter to a shift detector 117 of a decoding unit 108.

The decoding unit 108 decodes address information based on the multiplication result of the multiplication unit 105 and the value of the synchronization counter output from the MSK synchronization detection unit 107. The sample-and-hold signal SH2 from the carrier signal generation unit 104 is a pulse signal output when the phase thereof becomes 0° relative to that of the carrier signal cos (ωt). When the sample-and-hold signal SH2 is not output, the integrator 116 performs integration in response to the sample-and-hold signal SH2. When the sample-and-hold signal SH2 is output, the integrator 116 outputs an integrated value obtained at that time as an S/H value, and resumes integration from 0. For this reason, in the MSK mark section, the S/H value is equal to or smaller than 0, and in sections other than the MSK mark section, the S/H value is equal to or larger than 0.

For example, in the case of the data 1 unit as an ADIP of a BD, first to third wobbles and 13th to 15th wobbles correspond to MSK wobbles. In the case of the data 0 unit, first to third wobbles and 15th to 17th wobbles correspond to MSK wobbles. By utilizing the fact, when a value obtained by subtracting the sum of S/H values in a section in which the synchronization count value corresponds to 16 to 17, from the sum of S/H values in a section in which the synchronization count value corresponds to 13 to 14 is negative, the decoding result of “1” is obtained, and when the value is positive, the decoding result of “0” is obtained.

However, as described above, when the wobble signal is deformed due to the crosstalk, the section in which the S/H value becomes a negative value may be shifted forward or backward. Especially when the amplitude of the wobble signal is small, the decoding may be incorrectly performed. In order to solve such a problem, in the demodulation circuit shown in FIG. 13, the shift detector 117 of the decoding unit 108 detects the presence or absence of the shift, and an adder 118 and an adder 119 each shift a section to be added based on the detection result of the shift detector 117, thereby performing addition.

Specifically, the shift detector 117 compares the sign and the absolute value among three wobbles in the section (bit synchronization MSK mark section) in which the synchronization count value corresponds to 1 to 3, to thereby detect the shift. When the shift is not present, the adder 118 and the adder 119 add an S/H value of the section in which the synchronization count value corresponds to 13 to 14, and an S/H value of the section in which the synchronization count value corresponds to 16 to 17, respectively. A subtractor 120 subtracts the addition result of the adder 119 from the addition result of the adder 118.

On the other hand, when the detection result of the shift detector 117 indicates that the section is shifted forward by one section, the adder 118 and the adder 119 add an S/H value of the section in which the synchronization count value corresponds to 13 to 14, and an S/H value of the section in which the synchronization count value corresponds to 15 to 16, respectively. The subtractor 120 subtracts the addition result of the adder 119 from the addition result of the adder 118.

Further, when the detection result of the shift detector 117 indicates that the section is shifted backward by one section, the adder 118 and the adder 119 add an S/H value of the section in which the synchronization count value corresponds to 14 to 15, and an S/H value of the section in which the synchronization count value corresponds to 16 to 17, respectively. The subtractor 120 subtracts the addition result of the adder 119 from the addition result of the adder 118.

Note that a determiner 121 obtains digital information of “1” when the subtraction result of the subtractor 120 is negative, and obtains digital information of “0” when the subtraction result is positive, and then outputs the digital information.

In this manner, when the detection position of the MSK mark is shifted due to the crosstalk and the pseudo synchronization occurs, the demodulator shown in FIG. 13 detects the shift in the detection position of the MSK mark, and corrects the synchronization position, which is used as the reference for the decoding of address information, according to an amount of the shift, to thereby decode the address information based on the corrected synchronization position. As a result, more accurate address information can be obtained.

In a method typified by the method as disclosed in Japanese Unexamined Patent Application Publication No. 2005-327439, erroneous detection of an MSK mark is suppressed by the backward protection, and a pseudo synchronization state is prevented from occurring. Further, even if the pseudo synchronization is established, the out-of-synchronization is determined and resynchronization is performed, whereby the pseudo synchronization can be shifted to normal synchronization.

However, as described above, the crosstalk is generated with a period of several tracks, unlike the accidental noise. In view of this, in the method, the out-of-synchronization due to the effect of crosstalk is determined after the synchronization is established, and resynchronization is continually performed. In a period in which the resynchronization is performed, it is impossible to decode address information and it is also impossible to perform recording or reproducing processing. For this reason, the continual resynchronization deteriorates the processing efficiency of the system.

As described in the explanation of the method as disclosed in Japanese Unexamined Patent Application Publication No. 2004-134009, when the pseudo synchronization due to the crosstalk occurs, the shift in the detection position of the synchronization signal is detected, and the synchronization position is corrected according to the amount of the shift. Then, the address information is decoded based on the corrected synchronization position, whereby the pseudo synchronization can be shifted to the normal synchronization without performing resynchronization. That is, if the pseudo synchronization due to the crosstalk can be detected, continual resynchronization can be avoided.

The method as disclosed in Japanese Unexamined Patent Application Publication No. 2004-134009 includes two approaches. One of the approaches is to set the length of a section to be integrated, to be as short as a half carrier period, and to perform multiplication only when a multiplied output is negative, in a similar manner as in the MSK detection unit 106 shown in FIG. 13. As a result, it is considered that the accuracy for detecting an MSK mark can be enhanced, and even if crosstalk is generated, the shift in the detection position of the MSK mark can be suppressed within one wobble section. The other approach is that the shift detector 117 of the decoding unit 108 detects the presence or absence of the shift in the detection position of the MSK mark, and further detects, when the shift is present, that the detection position is shifted forward by one section or shifted backward by one section. Then, the adder 118 and the adder 119 change the shape of a wobble to be added based on the detection result of the shift detector 117, whereby the address information can be decoded with accuracy. In the method, it is necessary to suppress the shift in the detection position of the MSK mark. Accordingly, as apparent from the comparison with the demodulator shown in FIG. 13, the circuit (MSK detection unit 106) for detecting an MSK mark has a complicated configuration and has a large scale.

### SUMMARY

In one embodiment of the present invention, there is provided a wobble signal demodulation method including: reading an MSK-modulated wobble signal from an optical recording disc having a track formed therein corresponding to the wobble signal; detecting MSK marks periodically placed as a synchronization signal, from the wobble signal read; establishing synchronization with a detection position of each of the MSK marks detected being set as a synchronization position; continuously detecting the MSK marks after the establishment of synchronization, and periodically generating a prediction timing indicating a timing at which each of the MSK marks is to be detected, based on the synchronization position; comparing a timing at which each of the MSK marks is detected, with the prediction timing corresponding to the timing, after each of the MSK marks is detected at a predetermined position within a period a predetermined number of times in succession; and determining the synchronization position as a crosstalk pseudo synchronization position due to crosstalk, on condition that there is a shift between the timings.

Note that the wobble signal demodulation method of the above embodiment replaced by a device or a system is effective as an embodiment of the present invention.

According to the technology of the present invention, in a case of demodulating address information from an MSK-modulated wobble signal, the pseudo synchronization due to crosstalk can be detected with a small circuit scale.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram for explaining the principle of the present invention;

FIG. 2 is a diagram showing a wobble demodulator according to an embodiment of the present invention;

FIG. 3 is a timing chart showing a flow of processing executed by the wobble demodulator shown in FIG. 2;

FIG. 4 is another timing chart showing a flow of processing executed by the wobble demodulator shown in FIG. 2;

FIG. 5 is still another timing chart showing a flow of processing executed by the wobble demodulator shown in FIG. 2;

FIG. 6 is a diagram showing the configuration of ADIP units;

FIG. 7 is a diagram showing the configuration of an ADIP word;

FIG. 8 is a diagram showing the configuration of an RUB;

FIG. 9 is a diagram showing an example of a conventional wobble demodulator;

FIG. 10 is a diagram for explaining a method of detecting an MSK modulation mark;

FIG. 11 is a diagram for explaining an effect of crosstalk on a detection position of an MSK modulation mark;

FIG. 12 is a diagram for explaining an effect of crosstalk on decoding of address information; and

FIG. 13 is a diagram showing another example of a conventional wobble demodulator.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Prior to explanation of specific embodiments of the present invention, the principle of the present invention is first described.

As a result of extensive study and trial and error on the effect of crosstalk on a synchronization signal detection position (position for detecting a center wobble of an MSK mark) in a case of detecting a synchronization signal (first MSK mark of synchronization blocks) from an MSK-modulated wobble signal, the inventor of the present invention has discovered the following fact.

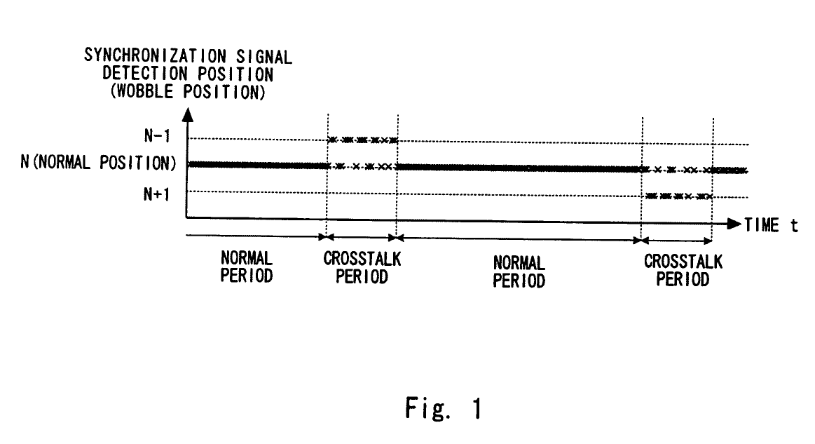

In FIG. 1, a symbol “x” denotes a synchronization signal detection position. Note that each detection position indicates a position (wobble position) of a detected synchronization signal within a period. As shown in FIG. 1, in a normal period in which crosstalk is not generated, the synchronization signal detection positions are constantly stable at a predetermined position (normal position N) within the period. Accordingly, intervals between the synchronization signal detection positions are constant. On the other hand, in a period in which crosstalk is generated, the synchronization signal detection positions are unstable and vary in units of wobbles. Accordingly, the intervals between the synchronization signal detection positions are not constant.

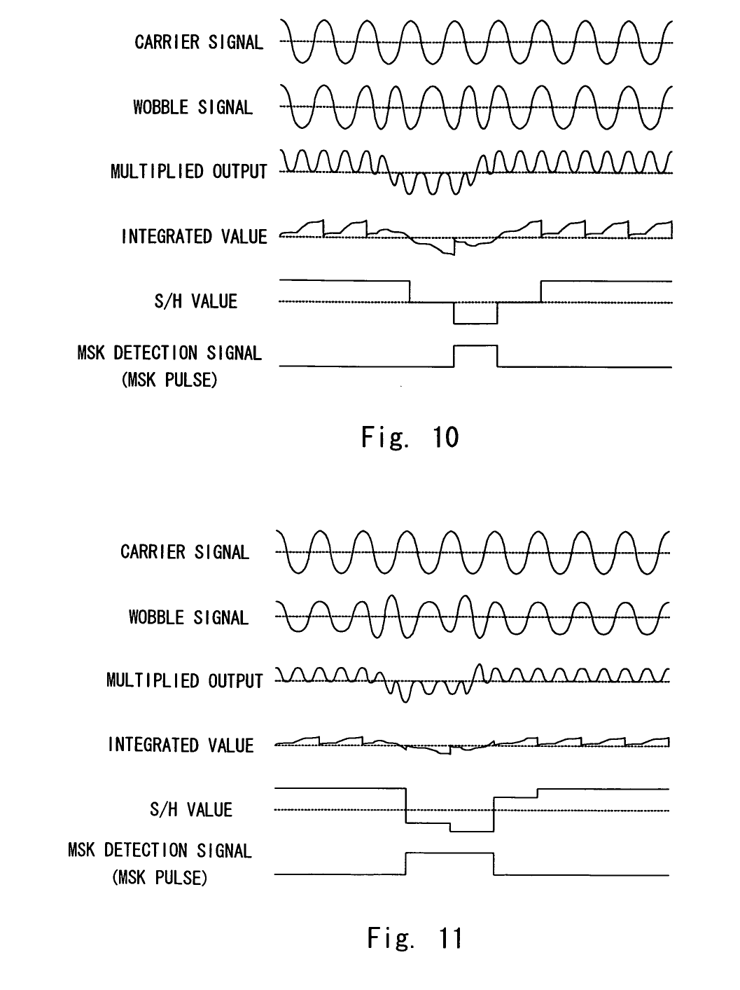

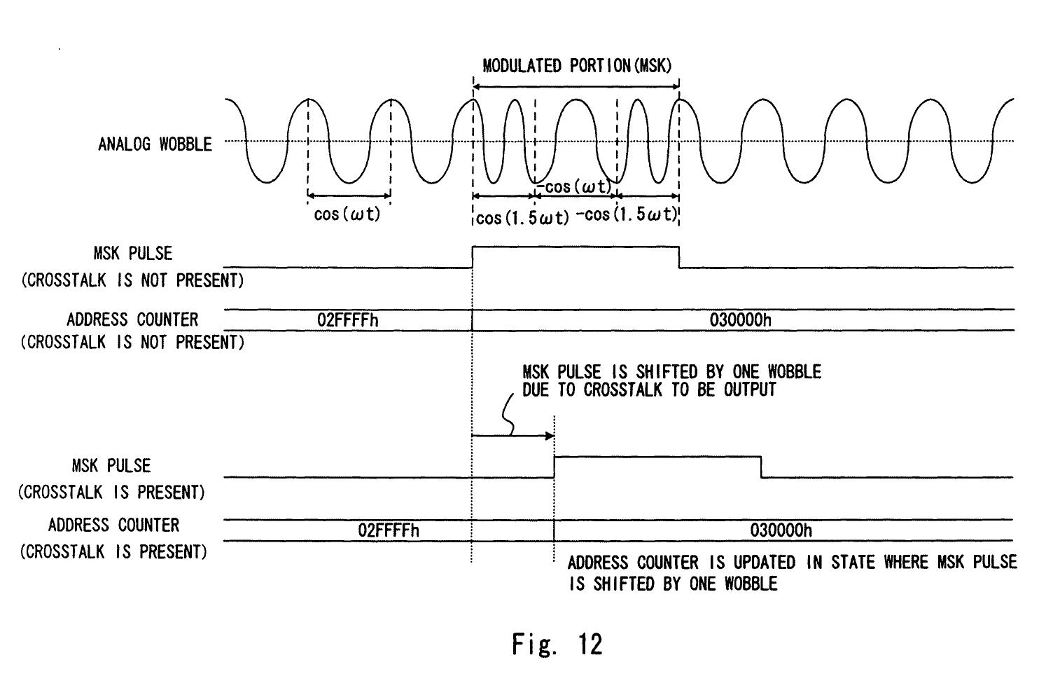

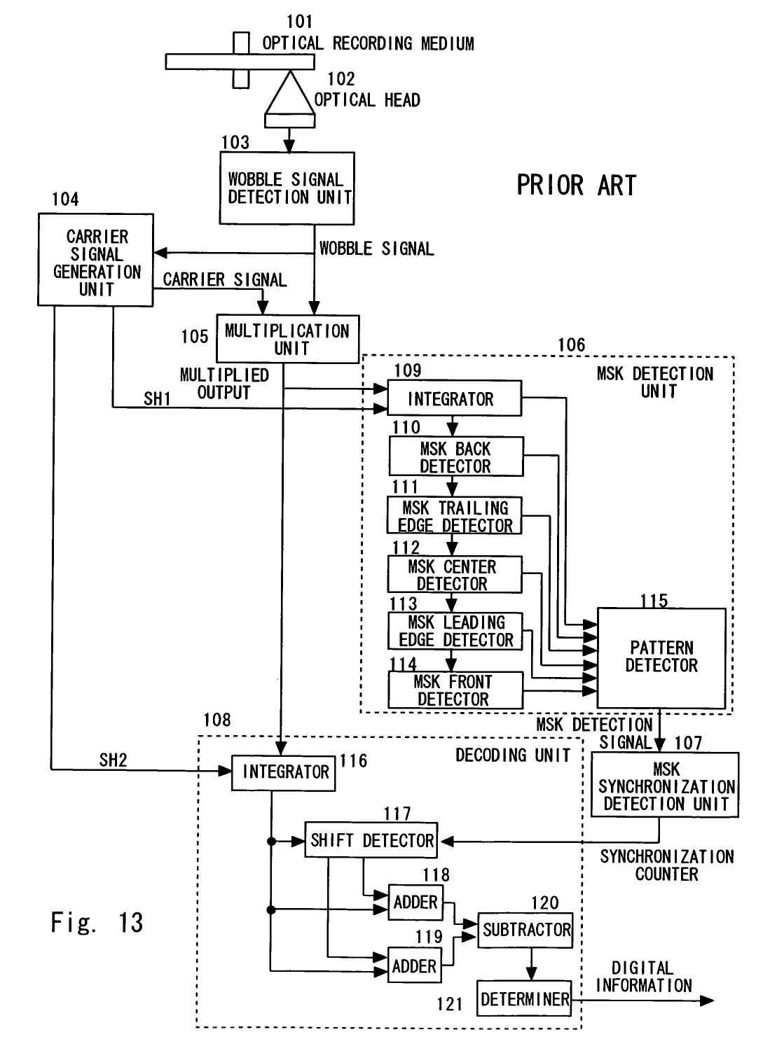

Such characteristics are commonly found in any method of detecting a synchronization signal, such as the methods disclosed in Japanese Unexamined Patent Application Publication Nos. 2005-327439 and 2004-134009. This occurs for the following reason. That is, as a recording density of an optical disc is increased, an arrangement pitch of tracks tends to be narrowed, and an S/N ratio or a C/N ratio of a wobble signal read from an optical disc tends to be reduced. Against this background, when crosstalk is generated, deterioration or phase inversion of the wobble signal is more likely to occur in the wobble signal. As in the method disclosed in Japanese Unexamined Patent Application Publication No. 2005-327439, when a wobble signal and a synchronization signal pattern are compared with each other to detect an MSK mark, an error is likely to occur due to the effect of crosstalk, and the position of the detected MSK mark varies. The same is applied to the method as disclosed in Japanese Unexamined Patent Application Publication No. 2004-134009, and the method is described with reference to FIGS. 10 and 11.

FIG. 10 shows a mode of each signal obtained in a case of detecting an MSK mark in the normal period. FIG. 11 shows a mode of each signal obtained in a case of detecting an MSK mark in a crosstalk period. As apparent from a comparison between integrated values shown in FIGS. 10 and 11, an amplitude of a multiplied output of a wobble signal and a carrier signal obtained in the crosstalk period is smaller than that obtained in the normal period. It is considered that this is because the wobble signal is deformed due to the crosstalk. As a result, an error is likely to occur in a case of obtaining an S/H value, and the position of the MSK mark indicated by the MSK pulse obtained based on the S/H value also varies.

Based on the above knowledge, the inventor of the present invention has achieved a method of determining crosstalk pseudo synchronization. Specifically, after synchronization is established and a synchronization position is determined, a synchronization signal is continuously detected, and a prediction timing indicating a timing at which the synchronization signal is to be detected is periodically generated based on the synchronization position. Then, it is determined whether the synchronization position corresponds to a synchronization position of the pseudo synchronization due to crosstalk (hereinafter, referred to as “crosstalk pseudo synchronization position”). It is assumed that the timing of the determination is set in the normal period in which the crosstalk is not generated. As described above, the wobble position of the detected synchronization signal varies in the crosstalk period, and the wobble position of the detected synchronization signal is stable in the normal period. Accordingly, in the method according to the present invention, after the synchronization is established, the synchronization signal is detected at a predetermined position within a period a predetermined number of times in succession, and then it is determined whether the synchronization position corresponds to the crosstalk pseudo synchronization position. As a determination method, a timing at which the synchronization signal is detected is compared with a prediction timing corresponding to the timing, to thereby determine the synchronization position as the crosstalk pseudo synchronization position on condition that there is a shift between the timings.

In the method, it is determined whether the synchronization position corresponds to the crosstalk pseudo synchronization position in the normal period, whereby a more accurate determination result can be obtained.

Further, in the case of detecting the synchronization signal, there is no need to provide an additional device to suppress a shift in a detection position of an MSK mark, unlike the MSK detection unit 106 of the demodulator shown in FIG. 13. As a result, the circuit scale and costs for the device can be suppressed.

Further, in the decoding unit 108 of the demodulator shown in FIG. 13, the shift detector 117 compares a sign and an absolute value among three wobbles of an MSK mark serving as a synchronization signal, to thereby detect the shift. Accordingly, it seems necessary to provide a plurality of computing units. Meanwhile, in the method according to the present invention, the prediction timing and the detection timing of the synchronization signal are compared with each other, and the crosstalk pseudo synchronization is determined based on the presence or absence of the shift between the timings. As a result, determination of the crosstalk pseudo synchronization and obtainment of a shift direction and a shift amount (shift information) of the synchronization signal detection position due to crosstalk can be performed at the same time. Therefore, in terms of the determination of the crosstalk pseudo synchronization and the obtainment of the shift amount, the method according to the present invention can be achieved with a simpler and smaller circuit as compared with the method for the demodulator shown in FIG. 13.

In consideration of the above description, a device that embodies the principle of the present invention will be described.

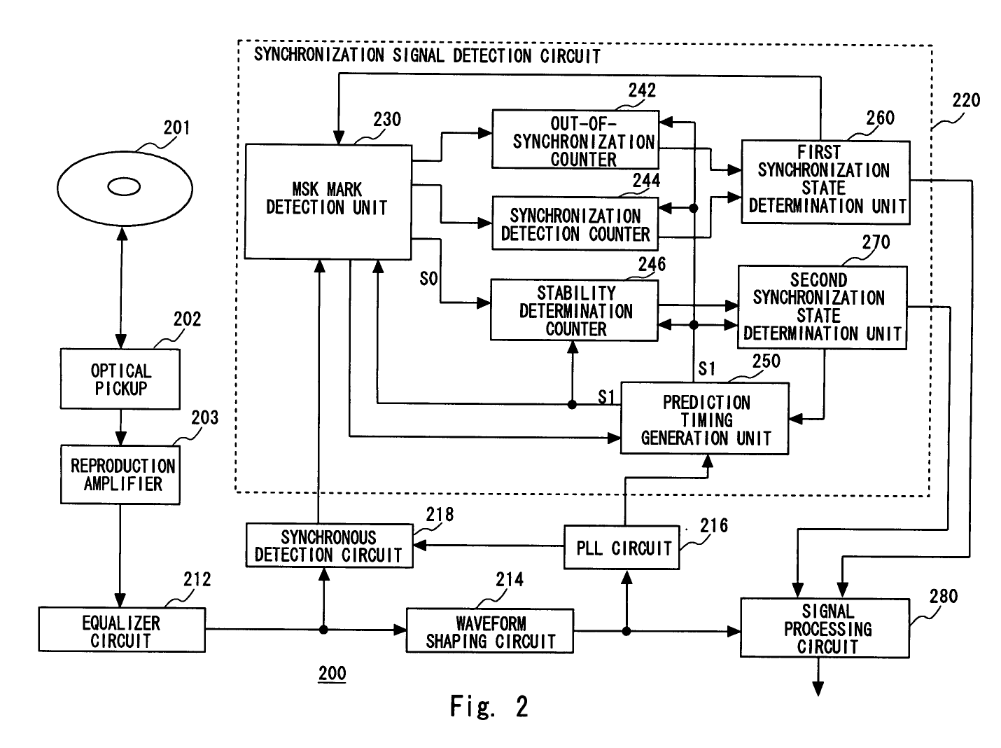

FIG. 2 shows a wobble demodulator 200 according to a first embodiment of the present invention. The wobble demodulator 200 demodulates an MSK-modulated wobble signal and processes a BD, for example.

As shown in FIG. 2, the wobble demodulator 200 includes an optical pickup 202, a reproduction amplifier 203, an equalizer circuit 212, a waveform shaping circuit 214, a PLL circuit 216, a synchronous detection circuit 218, a synchronization signal detection circuit 220, and a signal processing circuit 280. The optical pickup 202 irradiates a disc 201 with a laser beam and receives light reflected therefrom, to thereby obtain a read signal. The reproduction amplifier 203 amplifies the read signal obtained by the optical pickup 202. The equalizer circuit 212 suppresses intersymbol interference due to deformation of the waveform of the read signal amplified by the reproduction amplifier 203, and obtains an analog wobble signal. The waveform shaping circuit 214 shapes the waveform of the analog wobble signal obtained by the equalizer circuit 212 to convert the analog wobble signal into a pulse signal. The PLL circuit 216 generates a basic clock synchronized with the wobble, from an output signal of the waveform shaping circuit 214, by using a VOC or the like. The synchronous detection circuit 218 samples the analog wobble signal based on the basic clock obtained by the PLL circuit 216, and obtains a digital wobble signal (hereinafter, referred to simply as “wobble signal”). The synchronization signal detection circuit 220 detects a synchronization signal from the wobble signal obtained by the synchronous detection circuit 218. The signal processing circuit 280 performs decoding of address information and reproduction or recording of data in response to the pulse signal obtained by the waveform shaping circuit 214 based on the detection result of the synchronization signal detection circuit 220.

The synchronization signal detection circuit 220 includes an MSK mark detection unit 230, an out-of-synchronization counter 242, a synchronization detection counter 244, a stability determination counter 246, a prediction timing generation unit 250, a first synchronization state determination unit 260, and a second synchronization state determination unit 270.

The first synchronization state determination unit 260, which is described in detail later, determines a synchronization state as a synchronization locked state or an out-of-synchronization state, based on a count value of each of the out-of-synchronization counter 242 and the synchronization detection counter 244, and outputs the determination result to the MSK mark detection unit 230 and the signal processing circuit 280.

The MSK mark detection unit 230 detects the MSK mark from the wobble signal, and performs processing depending on the synchronization state based on the determination result of the first synchronization state determination unit 260.

In the synchronization locked state, that is, in a state in which synchronization is established and the synchronization position is determined, the MSK mark detection unit 230 detects an MSK mark based on the prediction timing generated by the prediction timing generation unit 250, within a predetermined length of period (detection window) that includes the prediction timing. When the MSK mark can be detected within the detection window, a signal indicating that the MSK mark can be detected is output to the out-of-synchronization counter 242 and the synchronization detection counter 244, and a signal S0 indicating a detection timing (hereinafter, referred to as “detection timing signal”) is output to the stability determination counter 246. On the other hand, when the MSK mark cannot be detected within the detection window, a signal indicating that the MSK mark cannot be detected is output to the out-of-synchronization counter 242 and the synchronization detection counter 244.

In the out-of-synchronization state, the MSK mark detection unit 230 detects the MSK mark at every timing until a time when the MSK mark can be detected. Upon detection of the MSK mark, the MSK mark detection unit 230 outputs the signal indicating that the MSK mark can be detected to the out-of-synchronization counter 242, the synchronization detection counter 244, and the prediction timing generation unit 250. After that, the prediction timing generation unit 250 detects the MSK mark within the detection window at the prediction timing generated based on the signal.

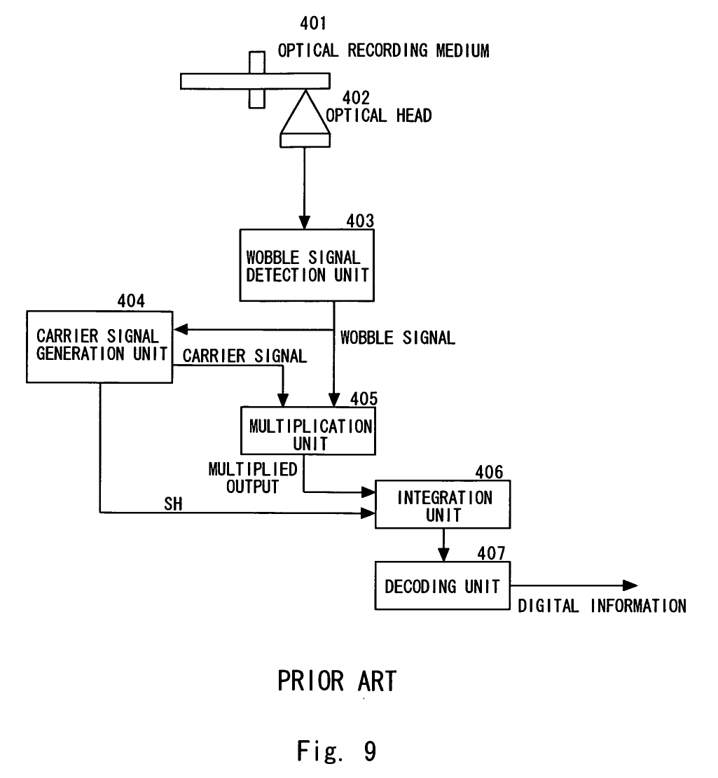

Note that, as a method of detecting the MSK mark by the MSK mark detection unit 230, there can be employed the method involving the comparison between a wobble signal and a synchronization signal pattern as disclosed in Japanese Unexamined Patent Application Publication No. 2005-327439. Alternatively, as in the demodulator shown in FIG. 9, there can be employed the method of multiplying a wobble signal by a carrier signal to be integrated, to thereby detect the MSK mark based on an integrated value.

The prediction timing generation unit 250 predicts a timing at which the synchronization signal is to be subsequently detected based on the synchronization position (detection position of synchronization signal) obtained when synchronization is established. Then, the prediction timing generation unit 250 outputs a prediction timing signal S1 to the MSK mark detection unit 230, the three counters, and the second synchronization state determination unit 270.

In the method as disclosed in Japanese Unexamined Patent Application Publication No. 2005-327439, to prevent the crosstalk pseudo synchronization from being detected as the normal synchronization, the detection window for detecting the synchronization signal needs to be set small. As described later, in the embodiment of the present invention, there is no need to prevent the crosstalk pseudo synchronization from being detected as the normal synchronization by limiting the detection window for detecting the MSK mark. Therefore, the MSK mark detection unit 230 generates a detection window larger than that used for the method as disclosed in Japanese Unexamined Patent Application Publication No. 2005-327439, with the result that the synchronization signal can be detected within the detection window even in the case of crosstalk pseudo synchronization.

Upon receiving the signal indicating that the MSK mark can be detected, from the MSK mark detection unit 230, the out-of-synchronization counter 242 resets the count value to 0. Upon receiving the signal indicating that the MSK mark cannot be detected, the MSK mark detection unit 230 increments the count value by one.

Upon receiving the signal indicating that the MSK mark cannot be detected, from the MSK mark detection unit 230, the synchronization detection counter 244 resets the count value to 0. Upon receiving the signal indicating that the MSK mark can be detected, the synchronization detection counter 244 increments the count value by one.

The first synchronization state determination unit 260 constantly monitors the count value of each of the out-of-synchronization counter 242 and the synchronization detection counter 244 to determine the synchronization state. Specifically, when the count value of the synchronization detection counter 244 reaches a predetermined threshold value “A” (A: an integer equal to or greater than 2) in the out-of-synchronization state, the first synchronization state determination unit 260 determines the synchronization state as the synchronization locked state. When the count value of the out-of-synchronization counter 242 reaches a predetermined threshold value “B” (B: an integer equal to or greater than 2) in the synchronization locked state, the first synchronization state determination unit 260 determines the synchronization state as the out-of-synchronization state. Hereinafter, the threshold value “A” and the threshold value “B” are referred to as a “synchronization detection determination threshold value” and an “out-of-synchronization determination threshold value”, respectively.

Specifically, the MSK mark detection unit 230 detects the MSK mark as a candidate of the synchronization signal. Then, the first synchronization state determination unit 260 determines the synchronization locked state by using the MSK mark, which is the candidate of the synchronization signal, as a true synchronization signal, on condition that the MSK mark is detected “A” times in succession within the detection window set based on the detection position of the MSK mark, to thereby establish synchronization. Accordingly, the pseudo synchronization due to the accidental noise can be avoided. Further, in the synchronization locked state, the first synchronization state determination unit 260 determines the out-of-synchronization on condition that the MSK mark, which should appear as the synchronization signal within the detection window, is not detected “B” times in succession, to thereby perform resynchronization. As a result, after the establishment of synchronization, when the out-of-synchronization due to the accidental noise occurs, the normal synchronization can be restored.

In the synchronization locked state, the second synchronization state determination unit 270 determines the established synchronization as the normal synchronization or the crosstalk pseudo synchronization. The determination is made after it is determined that the current time is within the normal period based on the count value of the stability determination counter 246.

In the synchronization locked state, the stability determination counter 246 resets or increments the count value depending on whether the wobble position of the detected MSK mark is constant. Specifically, based on the detection timing signal S0 from the MSK mark detection unit 230 and the prediction timing signal S1 from the prediction timing generation unit 250, the stability determination counter 246 increments the count value by one when the wobble position of the MSK mark currently detected is the same as the wobble position of the MSK mark previously detected, and resets the count value to 0 when the wobble positions are not the same.

A larger count value of the stability determination counter 246 indicates that the detection position of the MSK mark is more stabilized, and a smaller count value of the stability determination counter 246 indicates that the detection position of the MSK mark varies and is instable. The second synchronization state determination unit 270 monitors the count value of the stability determination counter 246 to determine that the current time is within the normal period on condition that the count value reaches a predetermined threshold value “C”. Hereinafter, the threshold value “C” is referred to as a “stability determination threshold value”.

Upon determination of the normal period, the second synchronization state determination unit 270 compares the detection timing of the MSK mark subsequently detected by the MSK mark detection unit 230 with the prediction timing S1 generated by the prediction timing generation unit 250 so as to correspond to the detection timing. If the timings match, the second synchronization state determination unit 270 determines the synchronization as the normal synchronization and determines the synchronization position as a normal synchronization position. Meanwhile, if the timings do not match, the second synchronization state determination unit 270 determines the synchronization as crosstalk pseudo synchronization, that is, determines the synchronization position as a crosstalk pseudo synchronization position. In addition, the second synchronization state determination unit 270 outputs a signal indicative of the crosstalk pseudo synchronization, and shift information containing a shift amount and a shift direction between the detection timing and the prediction timing, to the prediction timing generation unit 250 and the signal processing circuit 280.

Upon receiving the signal indicative of the crosstalk pseudo synchronization from the second synchronization state determination unit 270, the prediction timing generation unit 250 corrects the synchronization position based on the shift information, and updates the prediction timing S1 based on the corrected synchronization position.

The signal processing circuit 280 performs decoding of address information and error detection/correction processing on decoded data. When the first synchronization state determination unit 260 determines the synchronization state as the out-of-synchronization state, the signal processing circuit 280 executes control for stopping processing such as data reproduction or recording. Further, upon receiving the signal indicative of the crosstalk pseudo synchronization from the second synchronization state determination unit 270 in the synchronization locked state, the signal processing circuit 280 corrects the synchronization position based on the shift information and decodes the address information based on the corrected synchronization position.

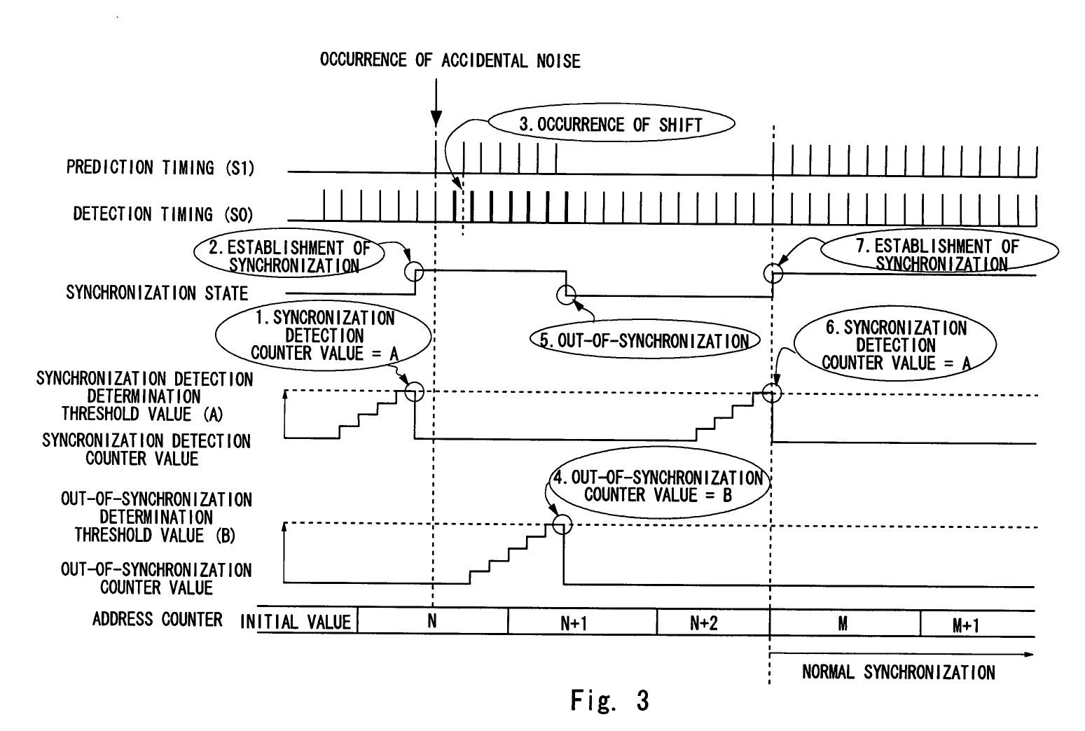

Referring to FIGS. 3 to 5, a description is given of a specific example of a flow of processing executed by the wobble demodulator 200 according to the embodiment of the present invention.

FIG. 3 is a timing chart showing a case where the accidental noise occurs in a state in which normal synchronization is established. Note that, for ease of understanding, it is assumed in this example that crosstalk is not generated, and description of processing performed by each of the stability determination counter 246 and the second synchronization state determination unit 270 is omitted.

As shown in FIG. 3, in Step 1, the count value of the synchronization detection counter 244 reaches the synchronization detection determination threshold value “A”. Thus, the first synchronization state determination unit 260 determines the synchronization state as the synchronization locked state, whereby the synchronization is established and the synchronization position is determined (Step 2). Based on the synchronization position, the prediction timing generation unit 250 generates the prediction timing signal S1 to be supplied to the MSK mark detection unit 230 and the counters. Further, the signal processing circuit 280 starts decoding of address information, and an address counter (not shown) included in the signal processing circuit 280 is incremented.

When the accidental noise occurs in the synchronization locked state, a shift is generated between the detection timing of the synchronization signal detected by the MSK mark detection unit 230 and the prediction timing S1 (Step 3). As a result of a continuous shift, the out-of-synchronization counter 242 is incremented, and then a count value thereof reaches the out-of-synchronization determination threshold value “B” (Step 4). Accordingly, the first synchronization state determination unit 260 determines the synchronization state as the out-of-synchronization state (Step 5).

In the out-of-synchronization state, in order to perform resynchronization, the synchronization signal is continuously detected by the MSK mark detection unit 230. As a result of continuous detection of the synchronization signal, the synchronization detection counter 244 is incremented, and then a count value thereof reaches the synchronization detection determination threshold value “A” (Step 6). Accordingly, the first synchronization state determination unit 260 determines the synchronization state as the synchronization locked state, and the synchronization is re-established (Step 7).

Further, the out-of-synchronization due to the accidental noise is corrected, whereby the normal synchronization is restored. The signal processing circuit 280 decodes the address information based on a new synchronization position obtained by the resynchronization, thereby making it possible to obtain the correct address information.

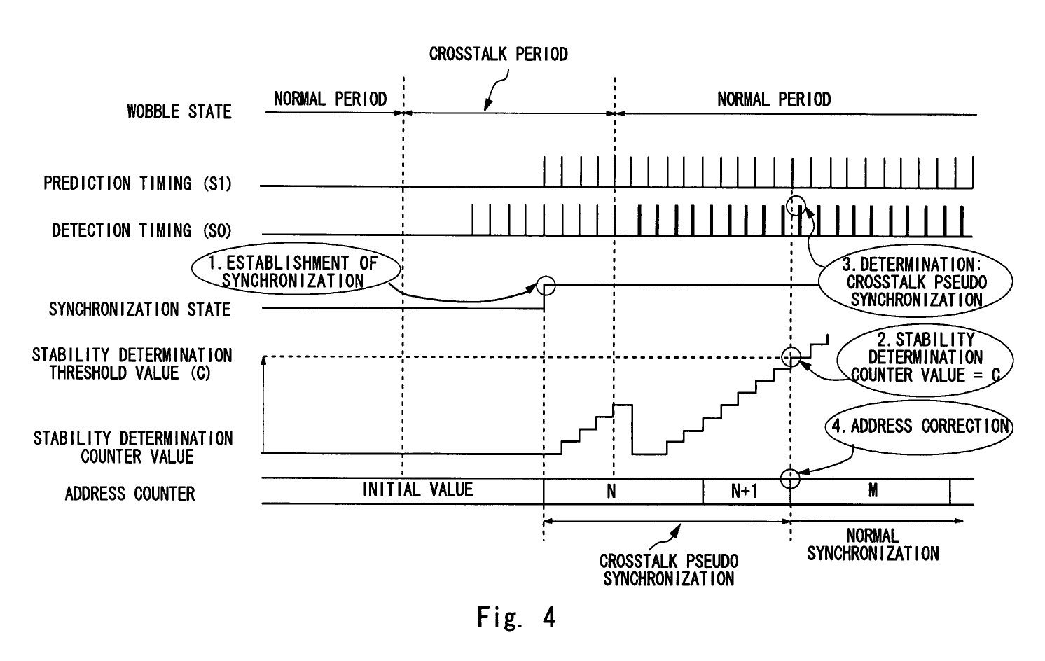

FIG. 4 is a timing chart showing a case where synchronization is established during the crosstalk period. For ease of understanding, it is assumed in this example that accidental noise does not occur, and description of processing performed by each of the out-of-synchronization counter 242 and the synchronization detection counter 244 is omitted.

As shown in FIG. 4, the synchronization is established in the crosstalk period (Step 1). Thus, the signal processing circuit 280 starts decoding of address information. Further, the prediction timing generation unit 250 starts generating the prediction timing S1 based on the synchronization position.

The wobble position of the synchronization signal detected during the crosstalk period varies, with the result that the count value of the stability determination counter 246 does not reach a large value. Accordingly, determination as to whether the established synchronization corresponds to the crosstalk pseudo synchronization is not made.

When the crosstalk period is shifted to the normal period, the wobble position of the detected synchronization signal is stabilized, and the stability determination counter 246 is incremented. Then, the count value reaches the stability determination threshold value “C” (Step 2). At this timing, the second synchronization state determination unit 270 determines the synchronization state as the crosstalk pseudo synchronization or the normal synchronization (Step 3). Because the synchronization is established during the crosstalk period, in Step 3, a shift is generated between the detection timing S0 of the synchronization signal and the prediction timing signal, whereby the crosstalk pseudo synchronization is determined. Note that the shift information is obtained and is output to the signal processing circuit 280 by the second synchronization state determination unit 270.

The signal processing circuit 280 corrects the synchronization position based on the shift information output from the second synchronization state determination unit 270 and decodes an address, thereby obtaining the correct address information.

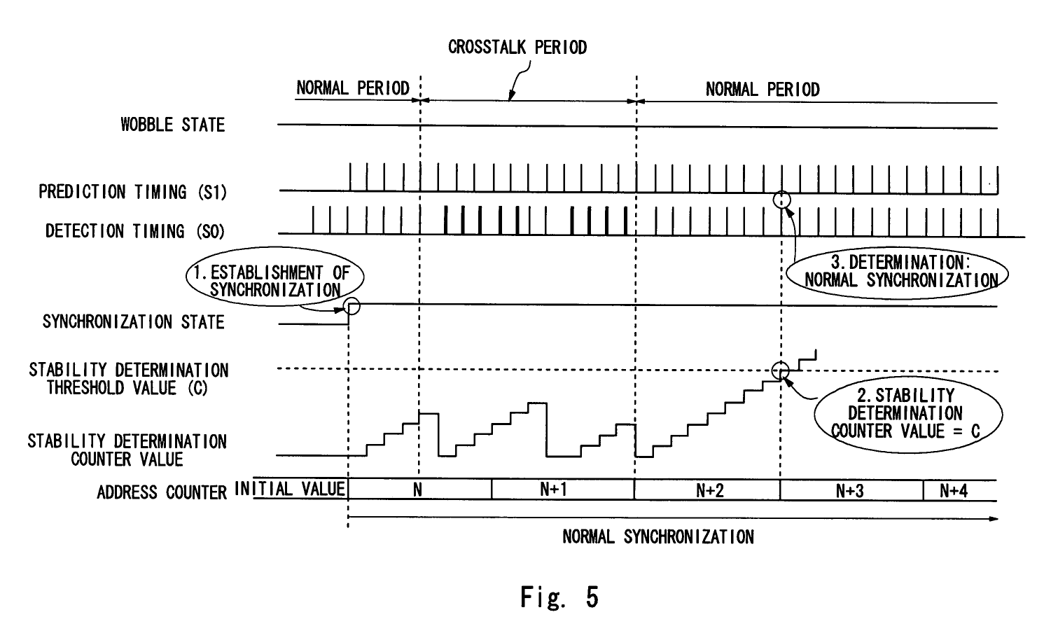

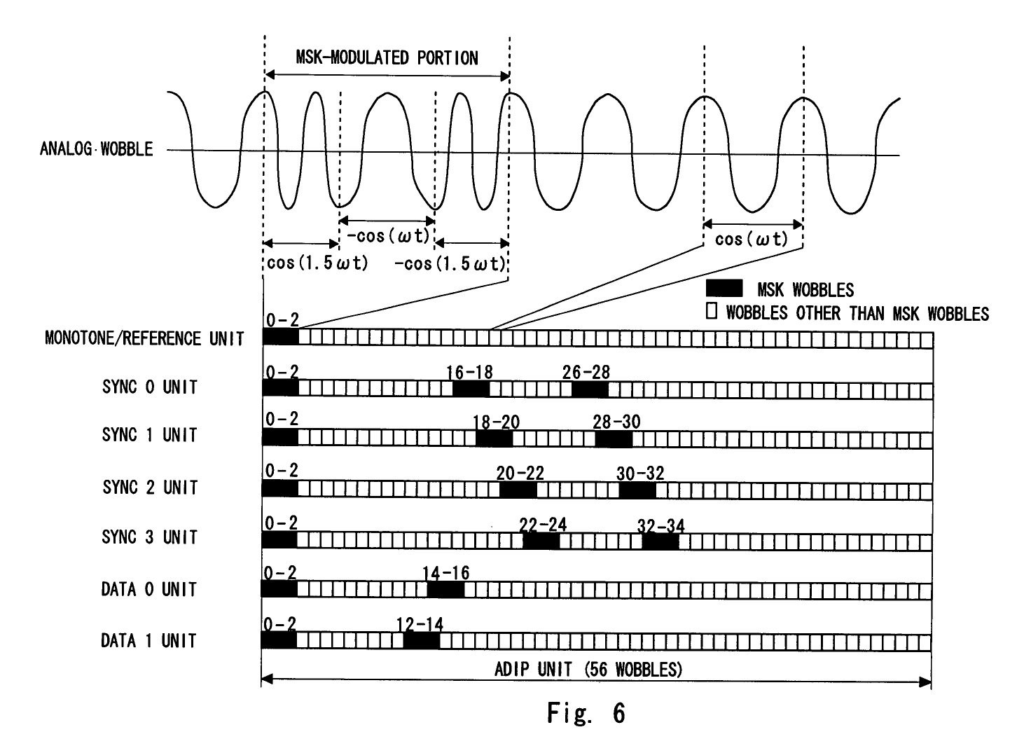

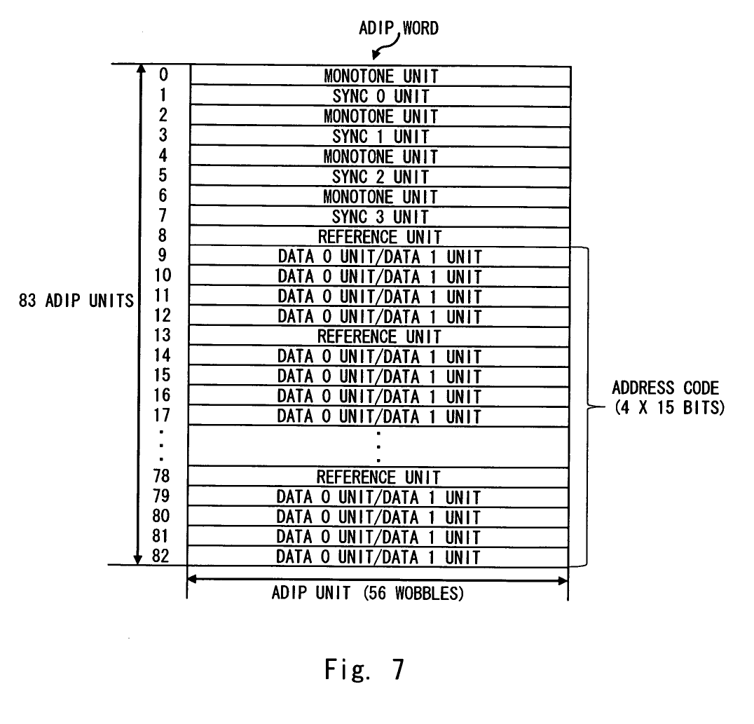

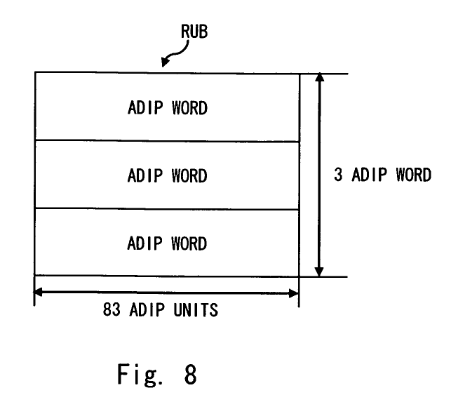

FIG. 5 is a timing chart showing a case where synchronization is established during the normal period. Also in this case, it is assumed that accidental noise does not occur, and description of processing performed by each of the out-of-synchronization counter 242 and the synchronization detection counter 244 is omitted.

As shown in FIG. 5, when the synchronization is established during the normal period (Step 1), the decoding of address information is started by the signal processing circuit 280 and the generation of the prediction timing S1 is started by the prediction timing generation unit 250.

After that, the crosstalk period starts, but the count value of the stability determination counter 246 does not reach a large value due to the variation in wobble position of the detected synchronization signal. As a result, the determination as to whether the established synchronization corresponds to the crosstalk pseudo synchronization is not made.

When the crosstalk period ends and the normal period starts, the wobble position of the detected synchronization signal is stabilized, with the result that the count value of the stability determination counter 246 increases. Then, the count value reaches the stability determination threshold value “C” (Step 2). At this timing, the second synchronization state determination unit 270 determines the synchronization state as the crosstalk pseudo synchronization or the normal synchronization (Step 3). Because the synchronization is established during the normal period, in Step 3, a shift is not generated between the detection timing of the synchronization signal and the prediction timing, whereby the normal synchronization is determined.

The wobble demodulator 200 according to the embodiment of the present invention embodies the principle of the present invention, and is capable of obtaining the effects as described in the explanation of the principle.

It is apparent that the present invention is not limited to the above embodiments, but may be modified and changed without departing from the scope and spirit of the invention.

What is claimed is:

1. A wobble signal demodulation method, comprising;
reading an MSK (Minimum Shift Keying)-modulated wobble signal from an optical recording disc having a track formed therein corresponding to the wobble signal;
detecting MSK marks periodically placed as a synchronization signal, from the wobble signal read;
establishing synchronization with a detection position of each of the MSK marks detected being set as a synchronization position;
continuously detecting the MSK marks after the establishment of synchronization and periodically generating a prediction timing indicating a timing at which each of the MSK marks is to be detected, based on the synchronization position;
comparing a timing at which each of the MSK marks is detected, with the prediction timing corresponding to the timing, after each of the MSK marks is detected at a predetermined position within a period a predetermined number of times in succession; and
determining, based on a result of the comparison, the synchronization position as a crosstalk pseudo synchronization position due to crosstalk, on condition that there is a shift between the timing and the prediction timing.

2. The wobble signal demodulation method according to claim 1, further comprising:
decoding address information provided in a position with a position of the synchronization signal within the period being used as a reference, based on the synchronization position, the address information indicating a physical position on the optical recording disc; and
correcting the synchronization position according to a direction and an amount of the shift obtained by the comparison, when the crosstalk pseudo synchronization position is determined, so as to obtain a normal synchronization position, and decoding the address information based on the normal synchronization position.

3. A wobble signal demodulator, comprising:
a reading unit to read an MSK (Minimum Shift Keying)-modulated wobble signal from an optical recording disc having a track formed therein corresponding to the wobble signal;
an MSK mark detection unit to detect MSK marks periodically placed as a synchronization signal, from the wobble signal read by the reading unit;
a first synchronization state determination unit to determine, based on a detection result of the MSK mark detection unit, one of a synchronization locked state in which synchronization is established with a detection position of each of the MSK marks being set as a synchronization position, and an out-of-synchronization state in which out-of-synchronization occurs;
a prediction timing generation unit to periodically generate a prediction timing indicating a timing at which each of the MSK marks is to be detected, based on the synchronization position in the synchronization locked state; and
a second synchronization state determination unit to compare a timing at which each of the MSK marks is detected, with the prediction timing generated by the prediction timing generation unit so as to correspond to the timing, after each of the MSK marks is detected at a predetermined position within a period a predetermined number of times in succession by the MSK mark detection unit, and to determine, based on a result of the comparison, the synchronization position as a crosstalk pseudo synchronization position due to crosstalk, on condition that there is a shift between the timing and the prediction timing.

4. The wobble signal demodulator according to claim 3, further comprising a decoding unit to decode address information provided in a position with a position of the synchronization signal within the period being used as a reference, based on the synchronization position, the address information indicating a physical position on the optical recording disc, wherein:
the second synchronization state determination unit outputs, to the decoding unit, shift information indicative of a direction and an amount of the shift obtained by the comparison, when the crosstalk pseudo synchronization position is determined; and
the decoding unit corrects the synchronization position based on the shift information output from the second synchronization state determination unit so as to obtain a normal synchronization position, and decodes the address information based on the normal synchronization position.

5. The wobble signal demodulator according to claim 3, further comprising a stability determination counter to increment a count value when a detection position of the MSK mark currently detected by the MSK mark detection unit and the detection position previously detected are the same within the period, and to reset the count value when the detection position currently detected and the detection position previously detected are different from each other, in the synchronization locked state,
wherein the second synchronization state determination unit determines whether the synchronization position corresponds to the crosstalk pseudo synchronization position, after the count value of the stability determination counter reaches a predetermined threshold value.

6. The wobble signal demodulator according to claim 4, further comprising a stability determination counter to increment a count value when a detection position of the MSK mark currently detected by the MSK mark detection unit and the detection position previously detected are the same within the period, and to reset the count value when the detection position currently detected and the detection position previously detected are different from each other, in the synchronization locked state,
wherein the second synchronization state determination unit determines whether the synchronization position corresponds to the crosstalk pseudo synchronization position, after the count value of the stability determination counter reaches a predetermined threshold value.

7. The wobble signal demodulator according to claim 3, wherein:
the MSK mark detection unit detects, in the synchronization locked state, the MSK marks within a detection window serving as a section with a predetermined length and including the prediction timing generated by the prediction timing generation unit; and
the first synchronization state determination unit determines, in the synchronization locked state, the out-of-synchronization state on condition that the number of times the MSK mark detection unit fails to detect the MSK marks within the detection window reaches a predetermined threshold value.

8. The wobble signal demodulator according to claim 4, wherein:
the MSK mark detection unit detects, in the synchronization locked state, the MSK marks within a detection window serving as a section with a predetermined length and including the prediction timing generated by the prediction timing generation unit; and
the first synchronization state determination unit determines, in the synchronization locked state, the out-of-synchronization state on condition that the number of times the MSK mark detection unit fails to detect the MSK marks within the detection window reaches a predetermined threshold value.

9. The wobble signal demodulator according to claim 5, wherein:
the MSK mark detection unit detects, in the synchronization locked state, the MSK marks within a detection window serving as a section with a predetermined length and including the prediction timing generated by the prediction timing generation unit; and
the first synchronization state determination unit determines, in the synchronization locked state, the out-of-synchronization state on condition that the number of times the MSK mark detection unit fails to detect the MSK marks within the detection window reaches a predetermined threshold value.

10. The wobble signal demodulator according to claim 6, wherein:
the MSK mark detection unit detects, in the synchronization locked state, the MSK marks within a detection window serving as a section with a predetermined length and including the prediction timing generated by the prediction timing generation unit; and
the first synchronization state determination unit determines, in the synchronization locked state, the out-of-synchronization state on condition that the number of times the MSK mark detection unit fails to detect the MSK marks within the detection window reaches a predetermined threshold value.
